(19) United States
(12) Patent Application Publication
(10) Pub. No.: US 2020/0369259 A1
(43) Pub. Date: Nov. 26, 2020

(54) HYBRID POWERTRAINS

(71) Applicant: AIQ HYBRID PTY LTD, Burwood (AU)

(72) Inventor: Fazul HUQ, Burwood (AU)

(73) Assignee: AIQ HYBRID PTY LTD, Burwood (AU)

(21) Appl. No.: 16/986,986

(22) Filed: Aug. 6, 2020

Related U.S. Application Data
(63) Continuation of application No. PCT/AU2019/050102, filed on Feb. 8, 2019.

(30) Foreign Application Priority Data
Feb. 9, 2018 (AU) 2018900411

(51) Int. Cl. B60W 20/11; B60W 10/06; B60W 10/08; B60W 10/26; B60W 20/13; B60W 40/105

(52) U.S. Cl. CPC B60W 20/11; B60W 10/06; B60W 10/08; B60W 10/26; B60W 20/13; B60W 2520/10; B60W 2510/242; B60W 2510/0604; B60W 2540/12; B60W 2510/0638; B60W 40/105

(57) ABSTRACT

A method and system of operating an internal combustion engine (ICE) of a hybrid powertrain system for powering a vehicle or stationary apparatus having a variable load demand includes arrangements and configurations of operating the ICE to charge/recharge capacitive energy storage, such as ultra-capacitors, during acceleration or high load demand on the ICE. Operation of the ICE can be transitioned from one mode of operation to another, more efficient, mode of operation during charging and high load. The present invention provides fuel efficiency/economy benefits when charging the capacitive energy storage during high load situations.

This nonprovisional application is a continuation of International Application No. PCT/AU2019/050102, which was filed on Feb. 8, 2019, and which claims priority to Australian Patent Application No. 2018900411, which was filed in Australia on Feb. 9, 2018, and which are both herein incorporated by reference.

### BACKGROUND OF THE INVENTION

### Field of the Invention

The present invention relates to hybrid powertrains, such as for vehicles and stationary engines.

The present invention finds particular application utilising capacitive storage, such as using one or more ultra-capacitors (also encompassing super-capacitors or supercaps), to store and release energy on demand.

The present invention will be described hereinafter in an explanatory manner with reference to a motorcycle. However, it will be appreciated that the invention is not limited to this particular application or field of use.

### Description of the Background Art

Manufacturers of powertrains for vehicles and stationary engines have been under immense pressure to deliver significant reductions in emissions and fuel consumption.

Internal combustion engines (ICEs) are constantly improving in their thermal efficiency. Direct fuel injection and turbo charging, and other technologies being applied to modern ICE have helped to improved fuel economy and allowed a general reduction in engine displacement for the same power outputs—that is, the specific output of ICEs has been increased.

However, it is still the case generally that ICE drivetrains operate in a less efficient mode when in part throttle applications v's open throttle. That is, an ICE will have different fuel efficiencies at different operating points with a general relationship being that increased throttle openings will have better fuel efficiency compared to more closed throttle operation. ICEs are complex in their behaviour regarding fuel efficiency at different points of their operation, and there are other parameters that must be considered in terms of emissions output, noise, vibration and harshness (NVH) of operation, and even more complex thermodynamic, fluid dynamic and even run-time interactions e.g. warm-up modes can have an effect.

However, for the purpose of understanding and appreciating the workings and benefits of the present invention, it is to be borne in mind that ICE powertrains do have points in their operation that are more efficient than other points in their operation.

After decades of improvements to the internal combustion engine, drivetrain manufacturers are now focusing on vehicle electrification as a solution to reducing emissions and fuel consumption.

There is a focus by manufacturers towards full electric powertrains, e.g. battery electric vehicles (BEVs), utilising rechargeable batteries to replace internal combustion engine powered drivetrains. Mainstream application of full electric powertrains however has several drawbacks which constrain widespread application today:
Weight penalty,
cost,
long charging time,
requirement for an external charging infrastructure, and
driving range/duration compared to the internal combustion engine. This can manifest as so called “range anxiety”, being a fear that a vehicle has insufficient range to reach its destination and would thus strand the vehicle's occupants mid-journey.

By way of example, a fully electric two-wheeler moped with 3 kW drive has a typical lithium ion battery voltage capacity of 72V, 24 Ampere hour (Ah) capacity. It has an average range of only 40 km and takes 6-7 hours to fully charge the discharged battery again. The equivalent 125 cc petrol two-wheeler with continuously variable transmission (CVT) transmission has a 5.5 L gasoline tank, has an average range of 214 km and takes 1 minute to re-fill. Furthermore, the street side infrastructure for recharging fully electric vehicles is not yet ubiquitous, unlike service/gas stations commonly available to obtain petrol (gasoline).

Until these constraints are overcome, manufacturers are relying on hybrid powertrain technology in hybrid electric vehicles (HEVs) as a means to reduce fuel consumption and emissions output in their vehicles.

Prior hybrid electric vehicle powertrains contain a battery pack as the traction battery. An on-board ICE is used to charge the battery pack and/or to augment drive to the wheels.

HEV powertrains containing these types of traction batteries possess several drawbacks. External charging infrastructure is required for charging large batteries (e.g. plug-in hybrid vehicle). The charging amperage (Amps) is limited to low currents to protect the lifespan of the battery as well as the infrastructure circuit capacity. This results in a full charge taking several hours to complete. Large battery packs to provide a reasonable range/duration for a vehicle are also expensive and heavy.

For hybrid powertrain with small battery packs, the range that the driven vehicle can run on with battery energy alone is limited, resulting in a small fuel saving benefit. Additionally, small battery packs can only be charged at a low charging amperage compared to discharge amperage, which means that a useful amount of energy is not available on demand regularly. Due to their small size, these battery packs are also very sensitive to driving style (i.e. heavy acceleration, excessive con-off′ braking and accelerating technique), which means the battery energy will be drained quickly, and because the batteries in such battery packs cannot charge fast, useful amounts of energy will not be readily available, particularly in intermittent stop/start driving typical many inner-city driving patterns.

Ultra-capacitors (UC's) provide an alternative to lithium ion batteries. UCs differ in that they store charge in an electric field instead of potential energy in chemical form in a battery.

Unlike lithium ion batteries, this allows ultra-capacitors to be charged at the same rate as they discharge their stored energy and at very high currents. This allows ultra-capacitors to be fully charged in seconds. Ultra-capacitors can also be cycled for a million cycles without losing capacity.

However, ultra-capacitors, particularly when considered for traction battery applications, have their drawbacks. Presently, ultra-capacitors only have 2% the specific energy (Watt-hour per kilogram—Wh/kg) of lithium ion batteries, which means an ultra-capacitor pack would be bigger and more expensive than a lithium-ion battery if both were required to deliver the same amount of energy.

Additionally, upon discharge, the ultra-capacitor voltage does not remain constant and must be charged to be of practical use again, which makes using ultra-capacitors as an energy source for long periods in a cycle problematic.

This has limited the use of ultra-capacitors as traction batteries in powered vehicles to mild hybrid applications such as stop-start systems and non-traction duties in, for example, driving electric auxiliaries for a short time with fuel saving benefits in the order of only 4-8%.

The method of charging the ultra-capacitor in start-stop systems relies on a kinetic energy re-generation energy (e.g. braking). From first principles of kinetic energy (KE=½ mv²), available vehicle braking energy is directly related to the mass of the vehicle (∝ m) and to the square of the vehicle velocity (∝ v²). For small vehicles, with a low speed and low inertia, the energy from regeneration is only suitable for stop-start and cannot provide sufficient recoverable energy for acceleration and constant speed drive.

US2009/0212626 (Snyder et al) is directed to having a fast-energy storage (FES) device (using ultra-capacitors (UCs)) and a long duration power device (e.g. chemical cells or fuel cells). The FES provides good protection to the battery and the battery minimises the required capacity of the UCs. In particular, US2009/0212626 discloses a control system to control the maximum current of the battery pack to protect the battery pack, and uses quick bursts of transient current from the UCs to supplement during accelerations. Most of the power to the UCs and batteries comes from regenerative braking, but also allows for regenerative braking to occur from the battery pack and/or an internal combustion engine (ICE) driven generator. US2009/0212626 is directed to plug-in hybrid electric vehicles (HEVs) where the main battery is charged and then used, in combination with the FES/UCs, to drive without activating the ICE at all until the battery is fully drained, and that the vehicle can be driven in primarily combustion engine mode with the electric motor/generator used to provide bursts of acceleration on demand and to capture energy from regenerative braking. US2009/0212626 teaches providing support from the UCs for transient bursts of power to protect the main battery from having to provide too high a current during periods of high loads. US 2009/0212626 does not address the problem of maintaining fuel efficiency in a hybrid electric powertrain or teach transitioning operation of an ICE from one mode to another, more efficient, mode to use excess power to charge the capacitive energy storage (such as UCs).

US2014/111121 (Wu) is directed to an auxiliary boost battery to assist a main battery in supplying high level current at a higher discharge rate. The specification is directed at pure electric drive without an ICE or using an ICE to charge batteries on-demand. US2014/111121 includes a boost battery being super-capacitors/Ultra-capacitors or a combination of battery cells and UCs. US2014/111121 discusses recharging UCs during regenerative braking and using a “buck-boost” converter to adjust output voltage to UC's during the variable braking force and speed. The use of a high performance boost battery is matched to the capacity of the main battery e.g. ⅓ or less than the main battery, and the main battery can be used to power the drive train or to charge the boost battery. US 2014/111121 is focused on the configuration of circuitry and control that allows the boost battery of a pure electric vehicle to be recharged from the main battery when the electric motor is not in high-performance mode. US 2014/111121 does not address the problem of maintaining fuel efficiency in a hybrid electric powertrain or teach transitioning operation of an ICE from one mode to another, more efficient, mode to use excess power to charge the capacitive energy storage (such as UCs).

There remains a need for a hybrid powertrain that can provide one or more of:
improve the overall efficiency of the powertrain incorporating an internal combustion engine for significant fuel and emission savings;
utilize the advantages of electric machines without needing to rely on external charging infrastructure and long charging times/slow charging rates; and
reduce the weight and cost penalties of energy storage devices.

With the aforementioned drawbacks of the prior art in mind, it has been found desirable to provide a hybrid powertrain that ameliorates one of more of those drawbacks or provides at least a useful alternative to currently employed hybrid powertrain techniques.

The high discharge/charge rates and long cycle life of ultra-capacitors are advantageous but a solution to using them for long periods in a cycle is required to have any significant fuel and emission saving advantage.

There remains a need for the ability to charge ultra-capacitors on-board at a higher rate than discharge at high currents so that ultra-capacitor stored electric energy is available for repeated use to maximize fuel economy and without impacting lifespan. The present invention, at least in one form, seeks to provides such a solution.

Another major concern that global automotive OEM's face is the significant difference in fuel economy and emissions between test cycles in laboratories and real-world driving results.

Typical real-world driving consists of stationary periods, accelerations, constant speeds and decelerations. Laboratory test cycles consist of all of these conditions, but it is rare that the drive cycle test results correlate with real world driving.

It is known that accelerations contribute significantly to fuel consumption and emissions. This is fundamentally due to physics of accelerating the mass component of the force equation.

F=ma=mΔV/Δt(mass×(change in velocity in time)).

The internal combustion engine is relatively inefficient during acceleration relative to an electric motor driven vehicle. To accelerate, a certain level of torque is required. Internal combustion engines need to achieve a certain revolution per minute (rpm) to reach a usable torque, this takes time and during that period the engine is inefficient.

The force to keep a vehicle at a constant speed is significantly less (square of the velocity and relatively independent of vehicle mass) than when it is under acceleration (proportional to mass and change in velocity over a period of time).

A major reason there is a discrepancy between real-world and test cycle data is the number of acceleration periods in a test cycle being significantly different to that of the real world.

Another major reason is the acceleration gradient profile in test cycles being significantly different to that of the real world. If a driver is regularly using a steeper acceleration gradient or is spending more time accelerating/decelerating than constant speeds found in the test cycle, there will be a discrepancy in fuel consumption observed.

There remains a need for a hybrid powertrain that is less sensitive to variations in driving patterns caused by increased accelerations and/or increased acceleration gradients. One or more forms of the present invention seeks to provide such a solution.

Transmission strategy is also fundamental for determining the fuel consumption and emissions of an internal combustion engine in powered vehicles.

The transmission controls the application of power by using gears and gear trains to provide speed and torque conversions from a rotating power source to another device. There are many types of transmissions but for the purpose of discussion there are low-cost transmissions and multiple speed gearboxes.

Generally, low-cost transmissions are desirable because they are inexpensive and easy to repair. However, during constant speed the torque demand is significantly lower than during acceleration but if the engine rpm is kept high due to the selected transmission gear ratio and fixed final gear ratio then the engine rpm may be higher than what is required to meet the torque demand, or to put it another way, the throttle may be on a lesser opening as compared to the case where less rpm is used and greater throttle opening.

Additionally, during higher speed, if the engine rpm is kept high due to gear ratio limitations the engine rpm will operate at high rpm leading to high fuel consumption and emissions, again due to the fact that the engine is operating in an increased throttle mode than would be the case at lower rpm.

This is very typical of a low cost CVT transmission system on a 2-wheeler moped where the transmission is kept at a constant rpm at maximum torque normally up to 50 km/hr. This compromises the fuel economy at constant speed for the sake of having adequate performance during acceleration. It also has the disadvantage in that a very high rpm is required at higher speeds due to the fixed final gear ratio compromising fuel efficiency.

To some extent, multiple speed gearboxes (e.g. eight speed gearbox) have addressed the inadequacies of low-cost transmissions by matching torque requirements to minimize fuel consumption, but the multiple speed systems are complex and add significant cost to the vehicle. These multiple speed gearbox systems used in a variety of driven vehicle applications (e.g. four-wheeler, commercial vehicles).

There remains a need that eliminates constant speed and high-speed transmission inefficiencies for low-cost applications. There remains a need to reduce the high cost for complicated transmission applications.

### SUMMARY OF THE INVENTION

The present invention seeks to provide one or more improvements to a hybrid powertrain, which will overcome or ameliorate at least one or more of the deficiencies of the prior art, or to at least provide an alternative.

It will be appreciated that one or more forms of the present invention a hybrid powertrain system and related method(s) that allows an internal combustion engine (ICE) to be operated at points of higher efficiency, at least periodically or as demanded e.g. by a suitably configured control system, whilst allowing the hybrid powertrain system to deliver the power output demanded by the operator, such as to maintain a constant vehicle speed.

One or more forms of the present invention allows relatively low cost and robust ultra-capacitors (UCs) to be utilised as an electrical energy source for traction/drive motor application in a vehicle or stationary device. The UCs may be the only energy source powering drive or may be supplemented by other capacitive, battery and/or mechanical power, such as from an ICE.

Capacitive energy storage, such as using ultra-capacitors, is preferably (re)charged by regeneration.

One or more forms of the present invention provides on-demand charging of the capacitive energy storage, and transitions operation of the ICE into a more efficient mode when charging, and thereby saving fuel.

Existing hybrid vehicles with batteries (typically lithium-ion) have a different charging strategy compared to hybrids with capacitive storage. This is because hybrids with batteries maintain a constant voltage up to complete discharge of their batteries, whereas ultra-capacitors are continuously reducing in voltage while discharging.

Consequently, the present invention address a different problem, and arrives at a unique solution, than a hybrid or battery only system utilising solely standard (lithium-ion) batteries. The present invention ultilises a unique operating strategy compared to known strategies for charging/recharging such standard battery powered vehicles.

Benefit(s) to be gained by one or more forms of the present invention in terms of fuel consumption reduction (and preferably also emissions reduction) is/are surprising, remarkable and unexpected in light of the known art.

It will be appreciated that the present invention utilises efficiency differences at different modes (or points) of operation of ICEs.

In one aspect, the present invention changes an operating mode of an ICE which is supplying power and not recharging capacitive energy storage (such as one or more UCs) to another operating mode, and whilst at this other operating mode, also recharging the capacitive energy storage UCs.

One or more forms of the present invention provides an internal combustion engine (ICE) having a first operating mode at which the ICE is supplying electrical power and not recharging capacitive energy storage, and a second operating mode at which the ICE is recharging the capacitive energy storage.

At least one advantage provided by the present invention is that at that other operating mode, the ICE is operating at a higher efficiency and the UCs are charged during this time.

Once the UCs are charged the ICE can transition to the original or a different operating mode, and the UC energy can be deployed to assist the ICE as determined by the operating system (e.g. during next vehicle acceleration event, or indeed at many other possible operating points).

An aspect of the present invention provides a method of operating a hybrid power system providing a powertrain for powering a vehicle or stationary apparatus having a variable load demand, the method including: controlling operation of an internal combustion engine (ICE) to operate within a desired range of revolutions per minute (rpm) or at desired rpms to charge/recharge at least one electrical energy storage device including capacitive energy storage.

The capacitive energy storage may include, or be entirely provided by, at least one ultra-capacitor.

Preferably the at least one ultra-capacitor may or include individuals cells connected in series or parallel to provide sufficient voltage and capacity for the application.

Individual cells can be typically 2.5-3.0V and have a capacity of 650 Farad to 3000 Farad.

It will be appreciated that the term ultra-capacitor includes super-capacitors (aka supercaps) and other capacitors utilising electrostatic double-layer capacitance and electrochemical pseudo-capacitance that contribute to the total capacitance of the capacitor.

The ICE may have/provide a power output for use in powering the vehicle or stationary device and a charging output to charge the at least one electrical storage device, the ICE being controlled to change from a first mode of operation used to power the vehicle or stationary device to a second mode of operation used to power the vehicle or stationary device and to charge/recharge the at least one electrical energy storage device.

Power output of the ICE may be a mechanical output to power a mechanical drive arrangement or an electrical output to power at least one electric motor, or a combination of both mechanical and electrical.

The ICE may be controlled to operate in the second mode of operation while the at least one electrical energy storage device is used to power the at least one electric motor.

Power from the at least one electrical energy storage device may augment the power output from the ICE to power the vehicle or stationary device.

The second mode of operation of the ICE may be at a higher fuel efficiency operation and/or at a preferred emissions output of the ICE than the first mode of operation.

A combination of the operation parameters (torque demand, speed of vehicle and state of vehicle) may be provided or ‘read in’ by the control system.

A look up table for the internal combustion engine system can have stored the optimum or preferred combination of fuel consumption, torque and speed, which can be identified as the engine “sweet spot” mode of operation.

Based on the torque demand, speed and state of the vehicle, the second mode of operation will move the internal combustion engine into the “sweet spot” meeting the demand of the vehicle and also charging the ultra-capacitor.

The ICE may be controlled to return to a mode of operation (e.g. first mode) when the capacitive energy storage is charged/recharged to or above a threshold voltage or is controlled to maintain the capacitive energy storage at or above a threshold voltage or charge level.

A controller may be provided. The controller may be operated to determine a desired mode of operation of the ICE, such as, for example, from a memory containing efficiency parameters relating to operation of the ICE.

Efficiency parameters of the ICE may include one or a combination of two or more of fuel map “sweet spot”, throttle position, fuel-air ratio, load, gear ratio, rpm and speed. The second mode of operation may include the ICE operating parameters including one or a combination of two or more of fuel delivery timing, fuel delivery volume, fuel delivery rate, throttle position, fuel-air ratio, load, gear ratio, rpm and speed.

One or more forms of the present invention may include optimising weighted average fuel efficiency of the ICE, such as by controlling the ICE to transition from the first mode of operation to the second mode of operation to charge/recharge the capacitive energy storage when the second mode of operation is more fuel efficient for the ICE than the first mode when the capacitive energy storage is to be charged/recharged.

The second mode of operation may be determined from an electronic lookup map of possible operating modes for the ICE.

The second mode may be at a higher rpm operation of the ICE than the first mode.

The method may be applied to operation of a vehicle not having regenerative braking, or having regenerative braking but that is not used to charge/recharge the capacitive energy storage, when the ICE is operated in a mode to charge/recharge the capacitive energy storage.

At relatively lower efficiency operational mode(s) of the ICE, the at least one electrical energy storage device may be used to power or augment powering of the vehicle or the stationary device, and at a relatively higher efficiency operational mode of the ICE, the ICE is used to charge/recharge the at least one electrical energy storage device.

The relatively lower efficiency operational mode of the ICE may include an open throttle acceleration mode, low speed high load mode.

The internal combustion engine (ICE) may be put into an idle mode or high efficiency mode during a period when the at least one electrical energy storage device is powering the vehicle or the stationary device, and the ICE is operated to charge/recharge the at least one electrical energy storage device when an output voltage of the at least one electrical energy storage device falls to or below a threshold value.

The internal combustion engine (ICE) may be turned off during a period when the at least one electrical energy storage device is powering the vehicle or the stationary device or vehicle is stationary.

TABLE 1
Summary of configurations:

| | | Mode 2 High Efficiency | | | | |
|---|---|---|---|---|---|---|
| Configuration | Mode 1 Low Efficiency | Stationary | Deceleration | Acceleration | Constant Speed | Braking |
| Electric Drive with ICE | N/A | ICE off if fully | ICE off if fully | Electric Powertrain on and | Electric | Regen on |
| Generator (FIG. 7) | | charged | charged | ICE charging ultra-capacitor | Powertrain on | |
| | | | | at “Sweet Spot” | and ICE charging | |
| | | | | | ultra-capacitor at | |
| | | | | | “Sweet Spot” | |
| ICE with mechaniclal | ICE Drive to wheel under | ICE off if fully | ICE off if fully | Option 1. Electric Powertrain | Electric | Regen on |
| drive and Electric Power | acceleration full throttle. | charged | charged | on and ICE charging ultra- | Powertrain on | |
| Assist (FIG. 8) | ICE Drive at low speed | | | capacitor at “Sweet Spot” if | and ICE charging | |
| | with high load | | | torque available. Option 2. | ultra-capacitor at | |
| | | | | ICE Driving Vehicle with | “Sweet Spot” | |
| | | | | power assist from electric | | |
| | | | | drive and ultra-capacitor | | |
| | | | | energy if torque demand | | |
| | | | | high on engine to keep in | | |
| | | | | “sweet spot” | | |
| ICE with mechanical | ICE Drive to wheel under | ICE off if fully | ICE off if fully | Option 1. Electric Powertrain | Electric | Regen on |
| drive, electric drive and | acceleration full throttle. | charged | charged | on and ICE charging ultra- | Powertrain on | |
| Electric Power Assist | ICE Drive at low speed | | | capacitor at “Sweet Spot” if | and ICE charging | |
| (FIG. 9) | with high load | | | torque available. Option 2. | ultra-capacitor at | |
| | | | | ICE Driving Vehicle with | “Sweet Spot” | |
| | | | | power assist from electric | | |
| | | | | drive and ultra-capacitor | | |
| | | | | energy if torque demand | | |
| | | | | high on engine to keep in | | |
| | | | | “sweet spot”. | | |

One or more forms of the present invention may include switching the electric powertrain from a wye configuration to a delta configuration when a voltage output of the capacitive energy storage is at or below a threshold value.

A further aspect of the present invention provides a hybrid power system providing a powertrain for powering a vehicle or stationary apparatus having a variable load demand, the system including:
a. at least one electrical energy storage device including capacitive energy storage;
b. at least one internal combustion engine (ICE) operatively connected to drive a charging system, such as an on-board charging system and/or an electric power source, for use in charging/recharging at least the capacitive energy storage; and
c. a controller arranged and configured to control the ICE to transition operation from a first mode to a second mode more fuel efficient than the first mode when charging/recharging the capacitive energy storage.

The ICE may be controlled to operate within a desired range of revolutions per minute (rpm) in the second mode sufficient to charge/recharge the capacitive storage of the at least one energy storage device.

The on-board charging system and/or the electric power source may include a generator. A generator is to be understood encompass an electric generator, such as a dynamo or other device that may provide a direct current (DC) for use in charging the capacitive storage and/or any battery. The generator may encompass an alternator with rectified output for use in charging the capacitive storage and/or any battery provided.

The at least one electrical energy storage device may include a combination of at least one battery and capacitive energy storage, wherein the controller is arranged and configured to control the ICE such that the electric power source (e.g. generator) provides charging/recharging to the at least one battery and/or the capacitive energy storage.

The capacitive energy storage may include at least one ultra-capacitor.

The controller, such as an electronic control unit (ECU), may be arranged and configured to operate the ICE to charge/recharge the capacitive energy storage to maintain the at least one electrical energy storage device and/or the capacitive energy storage at or above a minimum voltage.

The system may utilise one or more embodiments of the aforementioned method(s).

The controller may be arranged and configured to transition operation of the ICE from a first mode to a second mode, the second mode being of higher rpm that the first mode, to charge/at least the capacitive energy storage.

The system may include an on-board charging system or electric power source, which may include or be the generator, operatively connected to or part of the ICE. The on-board charging system may be provided for on demand fast charging of an ultra-capacitor (super-capacitor) and supplying voltage and current to an electric machine/s to meet speed and torque demands of the vehicle.

One or more forms of the present invention has been developed for use in/with a system and/or apparatus for vehicles having an internal combustion engine, such as two wheelers (e.g. moped, motorcycle, scooter), three-wheelers (e.g. tricycle, tuk-tuk, auto-rickshaw), four wheelers (e.g. car, sports utility vehicles (SUV), commercial driven vehicles (e.g. taxis, limousines, vans, buses & trucks), heavy machinery (e.g. crane, tractor, bulldozer, loader, grader, excavator), marine vessels, and powered aircraft (such as helicopters, microlights, airplanes/aeroplanes).

For example, an on-board charging system may include one or more of each of the following or a combination of two or more thereof:
a generator, such as a low Kv (rpm/volt) (also known as the back EMF constant) generator;
an internal combustion engine (ICE), preferably optimised for high torque at low rpm; and
optionally a fixed gear torque multiplier, producing high voltage and charging currents at low rpm.

A constant high charging current can be induced, such as by maintaining a constant voltage differential between the ultra-capacitor and charging system voltage by controlling the rpm of the internal combustion engine using a solenoid connected to the throttle and operated by a controller, such as a (preferably, microprocessor based) Electronic Control Unit (ECU) controller.

The voltages of the ultra-capacitor and any associated charging system may be monitored, preferably continuously monitored, by an ECU, such as for closed loop feedback and protection against overcharging the ultra-capacitor pack.

One or more mechanical and/or electronic interlocks may be provided in the throttle to selectively limit rpm so that it is not physically possible to overcharge the capacitive energy storage e.g. ultra-capacitor.

The ultra-capacitor pack storage may be maintained or brought to full or near full charge frequently by charging at a higher current than the average discharge. This allows for more deceleration and stationary periods in time when the ICE can be fully turned off and no fuel is consumed.

The optional torque multiplier or equivalent ensures the ICE loading is matched to the generator Kv setting

One or more of a the combination of:
a low Kv generator with high voltage and high current output at low rpm;
optimized internal combustion engine for high torque at low rpm; and
a torque multiplier
   allows the ICE to operate at its “sweet spot” during operation more often than if it had been used to drive the vehicle directly.

As the energy stored in the ultra-capacitor is limited, the ultra-capacitor may not have sufficient capacity for constant or near constant discharge during long periods of constant speed.

One or more forms of the present invention can be provided to replicate the function of a sophisticated transmission system and eliminate the transmission all together. For example, the electric machine, can be reconfigured from a wye configuration to a delta configuration when the output voltage of the capacitive energy storage drops to or below a threshold value.

During constant speed, the ECU can detect the constant speed state of the vehicle. The electric machine/s drive controller/s enables the required set points for voltage and current to be applied to meet the constant speed Force equation requirements. The supplied power needs to be maintained constant for a particular constant speed.

The rpm of the ICE can be varied to ensure that the voltage delta between the on-board charging system and the capacitive storage device (e.g. ultra-capacitor(s)) is such that it induces a sufficient current so that the product of Voltage and Current supplies enough power to keep the vehicle at constant speed. This is equivalent of keeping a mechanical transmission in the tallest gear possible that will enable the combustion engine to provide just enough power for the constant speed. Spare voltage delta can be used to recharge the capacitive energy storage even while the capacitive energy storage is discharging.

The advantage of the on-board charging system is that it is infinitely variable based on what voltage delta and rpm the on-board charging system is at. This allows the on-board charging system to match the power requirements at constant speed without wasting any energy eliminating efficiencies seen with low cost transmissions.

With assisted drive power provided from the capacitive energy storage, the ICE can run at a lower RPM than if it were alone driving the wheels of the vehicle or powering the stationary device through a mechanical transmission. The ICE can be transitioned to a higher RPM mode, or maintained at a lower RPM mode if the load from the vehicle/stationary device changes, to recharge the capacitive energy storage.

Also disclosed is a method to improve the torque speed characteristic of a vehicle and/or stationary device (such as an electric machine) and range over which it operates.

Torque vs. speed characteristic is related to a low Kv constant. Changing the phase termination of the electric machine from wye to delta or delta to wye can vary the torque vs. speed characteristic. This is significant for optimised energy utilisation in, for example, super-capacitors and ultra-capacitors.

It will be appreciated that the use of the term ultra-capacitor or super-capacitor encompasses the other of those. Furthermore, reference to ‘a’, ‘an’ or ‘the’ ultra-capacitor encompasses multiple ultra-capacitors or one or more ultra-capacitor packs/banks.

As an ultra-capacitor's voltage is constantly decreasing with discharge, this limits the speed that the driving vehicle can achieve unless the ultra-capacitor energy is continuously topped up. This becomes more of a problem at higher speeds, as a higher voltage is required to achieve a higher speed. This impacts the rpm of the on-board charger, as it needs to increase rpm to sustain higher voltages. By including hardware to provide ECU controlled on the fly switching of the electric machine between wye (low speed high torque) and delta (high speed low torque) a greater speed range can be achieved at the same voltage.

At lower speed when high torque is required (e.g. during acceleration) the electric machine is kept in wye termination. At a certain speed that is dependent on the characteristics of the electric machine it is more optimum to switch to delta termination. This allows a high torque and higher top speed to be attained than if the electric machine were to remain in wye.

Switching between wye and delta can also be applied by the ECU microprocessor when the torque demand is low but there is a need for higher speed or constant speed. For the same voltage a higher speed can be achieved by switching from wye to delta, which allows the on-board generator ICE to work at a lower rpm and still obtain a higher vehicle top speed.

Also disclosed is a method (but not limited to) to optimize the operation of the on-board generator by determining the vehicle's state.

The states the vehicle could be in are:
i) stationary;
ii) acceleration;
iii) constant speed; and
iv) deceleration.

Identifying the vehicle's state enables the optimum operation of the on-board generator. Inputs: Voltage (Volts), Current (Shunt Volts), Throttle Position (0-5V), brake position (5V/0V) and Speed (Count) are read in by the ECU Microprocessor. The brake switch is monitored to identify if the brake is on.

The states are easily identifiable by the values of these inputs:
During the stationary state the current will be zero, the throttle position sensor will be zero, and the brake switch will be on.
During deceleration the current will be zero, the throttle position will be zero, the speed will be declining in time, and the brake switch may be on or off.
During acceleration the current will be greater than zero, the throttle position will be greater than zero, and the speed will be increasing with time.
During constant speed the current will be greater than zero, the throttle will be greater than zero, and the change of speed in time will be in a small range.
During deceleration when the brake is on regeneration can be activated.

Also disclosed is a method for optimizing fuel, emissions with the on-board charging system using the vehicle's state.

To maximize fuel and emissions savings the on-board charging system's ICE is turned off when work is not being done by the vehicle and the ultra-capacitor pack is fully charged. Work is not being done during stationary and deceleration states. If the ultra-capacitor pack is not fully charged the ultra-capacitor is rapidly charged during these states until it is full using constant current. Once full capacity is reached then the on-board charging system is turned off.

To maximize the fuel and emission saving during acceleration state the energy in the ultra-capacitor is discharged and the on-board charging system is turned on to provide a higher or matched charging current relative to the discharge current.

Preferably, the capacity of the ultra-capacitor is provided for the typical acceleration/operation gradient/profile and acceleration/operation time period/profile so that the full acceleration/operation characteristics can be captured/covered by the stored energy of the ultra-capacitor.

An example of the benefit of this would allow the internal combustion to be turned on and operate purely at its “sweet spot” during acceleration charging the ultra-capacitor at its most fuel efficient point for further time in electric mode. This allows the benefit of using the higher electric drive efficiency as well as running the internal combustion engine at its optimum fuel efficiency for charging the ultra-capacitor.

During constant speed states the energy in the ultra-capacitor is used first then the on-board charging system turned on to provide power requirement to sustain constant speed. The load on the engine would be increased by the charging demand of the UC's, the control system would increase the throttle opening whilst the user would not be required to alter the throttle demand—that is the increased load demand on the engine would be transparent to the operator and the Internal combustion engine (ICE) would operate at its efficiency “sweet spot”.

At any time while the on-board charging system is on, the rpm of the ICE can be varied to ensure that the voltage delta between the on-board charging system and the ultra-capacitor is such that it induces a sufficient current so that the product of Voltage and Current supplied produces the required power to provide a desired level of fuel and emissions reductions and charge the ultra-capacitor so that the energy is more readily available for acceleration states.

At any time when the ultra-capacitor (UC) is being discharged and the on-board charging system is off, the on-board charging system may be turned on at any time to sustain voltage and load demand by the application. The control system can be programmed such that if the UC drops below a certain voltage whilst it is being discharged, the on-board charging can be switched on to supply energy back in to the UC. This is being done concurrently while the internal combustion engine is being put into operation in its “sweet spot”. —

TABLE 2
Summary:

| | | Internal Combustion |
|---|---|---|
| State | Ultra-capacitor | Engine (ICE) |
| Stationary | Charging if required | On or Off |
| Deceleration | Charging if required | On or Off |
| Acceleration | Discharge first, | On second to supplement or |
| | charge if possible. | to charge if operating at |
| | | “sweet spot” |
| Constant speed | Discharge first, | On second to sustain |
| | charge if possible. | operating at “sweet spot” |

The energy storage device comprises of at least one ultra-capacitor pack containing individual ultra-capacitor cells connected in series to provide the voltage required.

The ultra-capacitor pack voltage will depend on the speed that is required for the application due to dependency of rpm per volt (Kv constant). Ultra-capacitor packs may be connected in parallel to enhance the energy storage volume. Balancing circuitry is included between individual cells.

In various embodiments, the internal combustion engine may be a petrol, diesel, LPG, CNG, ethanol fuelled engine or any other type of fuelled engine to take advantage of individual torque characteristics at low rpm, efficiency or cost of fuel.

In various embodiments the electric machine/s may be hub motors positioned within the wheels for simplicity or electric machines with gearing integrated into the system for the application or indeed combinations or other variations.

In various embodiments the electric machine/s may be positioned directly on the crankshaft of the engine to allow power assist and/or charging of the Ultra-capacitor.

In various embodiments when the electric machine/s are positioned on the crankshaft directly, a clutch system or solenoid switch may be used to engage/disengage the electrical load of the ultra-capacitor.

In various embodiments when the electric machine/s are positioned on the crankshaft directly a clutch system may be used to enable direct electric drive.

In various embodiments, to take full advantage of the efficiency of electric machines the drive wheel or wheels of the driven vehicle may be connected only to an electric machine/s and powered through a drive controller/s by the on-board charging system described and or by the energy stored in the ultra-capacitor. For these embodiments the transmission system that would normally exist between the internal combustion engine and driving wheel is deleted and is redundant.

In various embodiments it may be more practical to retain drive to the wheels both through the internal combustion engine as well as electric machines.

In such cases, the on-board generator and electric machine/s are used to drive vehicles up to what would be considered “practical” speeds. These practical speeds are typical for stop-start suburban driving and accelerations associated such suburban driving. This will maximize fuel savings and emissions where the ICE, on its own, would be highly inefficient at driving the vehicle.

Beyond that speed, the internal combustion engine can directly drive the rear wheels. Depending on that speed a simplified transmission can be included to meet the speed and torque demands at higher speeds.

In various embodiments, the normal battery for auxiliaries and starting of the internal combustion engine may be replaced by an ultra-capacitor pack in combination with a voltage regulator.

In various embodiments the ultra-capacitor stored energy may be used to enhance the acceleration performance of the vehicle by discharging at high current producing high torque.

The on-board charging system can recover the energy so that the energy is available for the next acceleration cycle.

In various embodiments the on-board charging system and energy stored in the ultra-capacitor may be used to drive auxiliary devices that use electricity on vehicles.

In various embodiments the on-board charging system and energy stored in the ultra-capacitor may be applied to optimize stationary engine systems.

A powertrain system embodying the present invention may include an internal combustion engine (ICE) having a first mode of operation at which the ICE is supplying electrical power and not recharging a capacitive energy storage, and a second mode of operation at which the ICE is recharging the capacitive energy storage.

The internal combustion engine (ICE) may be controlled to operate at the second mode of operation when the second mode of operation is more fuel efficient for the ICE than the first mode when the capacitive energy storage is to be charged/recharged.

The second mode of operation may include the ICE having operating parameters including one or a combination of two or more of fuel delivery timing, fuel delivery volume, fuel delivery rate, throttle position, fuel-air ratio, load, gear ratio, rpm and speed.

The second mode of operation may be an idle mode or high efficiency mode during a period when the capacitive energy storage is providing drive power, and the ICE is operated to charge/recharge the capacitive energy storage when an output voltage of the capacitive energy storage device falls to or below a threshold value.

The present invention represents an advance over prior art to minimise deficiencies of the prior art.

Other aspects of the invention are also disclosed with reference to accompanying drawings and examples.

A further aspect of the present invention provides a method of operating an internal combustion engine (ICE) of a hybrid powertrain system for powering a vehicle or stationary apparatus having a variable load demand, the method including: operating the ICE to charge/recharge capacitive energy storage of at least one electrical energy storage device during acceleration or high load demand on the ICE.

Another aspect of the present invention provides a hybrid power system providing a powertrain for powering a vehicle or stationary apparatus having a variable load demand, the system including an internal combustion engine (ICE) controlled to operate a generator to charge/recharge capacitive energy storage of at least one electrical energy storage device during acceleration or high load demand on the ICE.

The acceleration or high load demand may be at full throttle or very wide throttle opening of the engine.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is the World Motorcycle Test Cycle (WMTC) Stage 1 for two wheelers with the lower speed top speed curve for 150 cc capacity or less and the high top speed curve for greater than 150 cc.

FIG. 2 is the components of the on-board charging system for ultra-capacitor.

FIG. 3 is the torque speed characteristic for the same electric machine when terminated in wye and delta showing optimized switch point.

FIG. 4 shows the inputs required for the optimized ECU control of the on-board charging system and its values for stationary, deceleration, acceleration and constant speed states.

FIG. 5 shows an example of the IDC (Indian Drive Cycle).

FIGS. 6 to 8 show configurations of powertrain arrangements relating to one or more embodiments of the present invention.

### DETAILED DESCRIPTION

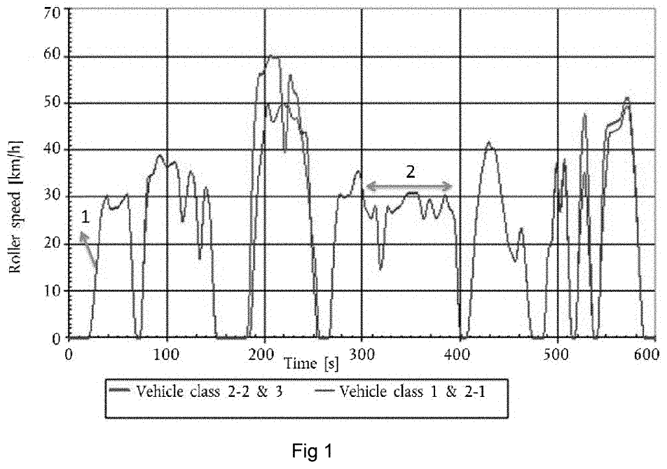

Referring to FIG. 1 it describes the World Motorcycle Test Cycle (WMTC) Stage 1 drive cycle. This is the typical world motorcycle test cycle for two wheelers with the low top speed curve for 150 cc capacity or less. The cycle can be broken down into stationary, acceleration, constant speed and deceleration states. WMTC Tests were conducted on various 100 cc two-wheelers with CVT transmission systems. Table 1 summarizes the average % fuel used for each state.

The test was repeated using a two-wheeler retrofitted with a Brushless Direct Current (BLDC) electric hub motor and removal of the internal combustion engine. Weight of the vehicle was maintained. An ultra-capacitor pack of 187.5 Farad consisting of sixteen 3000 Farad cells connected in series with active balancing was charged to 40V at the start of the test. The voltage was recorded to determine the energy used during discharge. Table 2 summarizes the energy used by an internal combustion engine with gasoline fuel compared to an electric hub motor drive using ultra-capacitors.

For energy calculations a constant of 34,342 Joules per millilitre (mL) of gasoline is used. Equation of:

W(Joules)=½C(Vmax²−Vmin²)

is used for ultra-capacitor energy where C is 187.5 Farad.

For the same acceleration profile the electric ultra-capacitor powertrain used only 20% of the energy the internal combustion engine used with gasoline. During the longest constant speed period of the WMTC cycle the electric ultra-capacitor powertrain used only 10% of the energy the internal combustion engine used with gasoline for the same period.

Similar results are obtained for other acceleration and constant speed sections of the WMTC drive cycle.

The difference in energy use during acceleration between the ultra-capacitor powertrain and the internal combustion engine is accounted for by the inefficiency of the petrol motor as compared to the electric machine and ultra-capacitor combination, however the significant variation at constant speed is due to the inefficiency of the transmission system. The electric drive with ultra-capacitor only supplies the power required to keep at constant speed. However, the internal combustion engine with CVT transmission keeps the rpm as high as 5000 rpm (max torque) resulting in increased wasted energy.

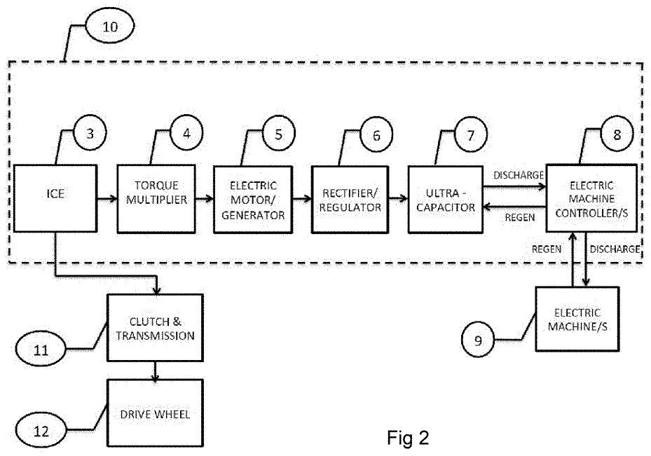

To maximize the use of electric powertrain but eliminate any need for dependence on external charging an on-board charging system (10) is used and is described in FIG. 2.

The system includes an internal combustion engine (ICE) (3) which may be optimized for high torque at low rpm; an optional torque multiplier (4); a generator (5) a rectifier/regulator (6); an ultra-capacitor pack/s (7); and an electric machine controller (8).

The internal combustion engine (ICE) (3) is connected to a generator (5) or through a torque multiplier (4).

This system (10) charges the ultra-capacitor (7) and/or provides power to the electric machine/s (9) through an electric machine/s controller (8). The generator (5) could also be an electric machine replacing electric machine/s (9) or used in combination with electric machine/s(9).

When generator (5) is acting as an electric motor it can power assist the ICE (3) to reduce load on the ICE (3).

In embodiments the generator (5) which may be in the form of a BLDC Generator (5). The generator (5) may be designed to have a low Kv using an increased number of turns per phase and terminated in wye configuration, which provides high voltage output at low rpm.

The generator (5) is also required to have a large current output at low rpm while avoiding saturation inefficiencies. This may be achieved by, but not limited to, increasing the strength of the magnets, increasing the physical size, changing the core material and/or adjusting the air gap.

A torque multiplier (4), which may be in the form of a fixed gear ratio between the internal combustion engine (ICE) (3) and the BLDC generator (5) can be used to optimise the matching of the torque capacity of the ICE (3) and output characteristics of the BLDC generator (5)

The ICE (3) used in the on-board charging system (10) may be optimized to provide a high torque at low rpm and is understood by those of skill in the art.

The ICE (3) may be connected to a clutch/transmission (11) and drive wheel (12) to provide propulsion.

A combination of low Kv BLDC generator (5), optimized ICE (3) for high torque at low rpm, and a fixed gear reduction torque multiplier (4) allow for a high voltage output to be supplied to the electric machine for top speed and high charging current to the ultra-capacitor pack/s (7) for fast charging. The ICE (3) operates at its “sweet spot” during charging of the ultra-capacitor.

In embodiments, to charge ultra-capacitors at a constant current the difference in voltage between the ultra-capacitor's (7) voltage and the output voltage of the generator (5) needs to be kept constant. As the ultra-capacitor (7) is being charged its voltage will increase.

To maintain the constant current so that rapid charging occurs the voltage output of the generator (5) must increase. The voltage of the ultra-capacitors (7) is monitored and the rpm of the generator (5) is controlled to maintain constant charging amperage up to full capacity.

During acceleration a high torque is required from the electric drive machine (7). High torque is achieved by terminating the windings in a wye termination. The disadvantage of this is that the top speed is reduced unless an increase in voltage is available.

For the same electric drive machine/s (9) a 1.73 multiple increase in Kv constant (rpm/volt) is achieved by terminating in delta. As speed is directly related to the Kv constant the top speed is also increased with reduced torque capacity.

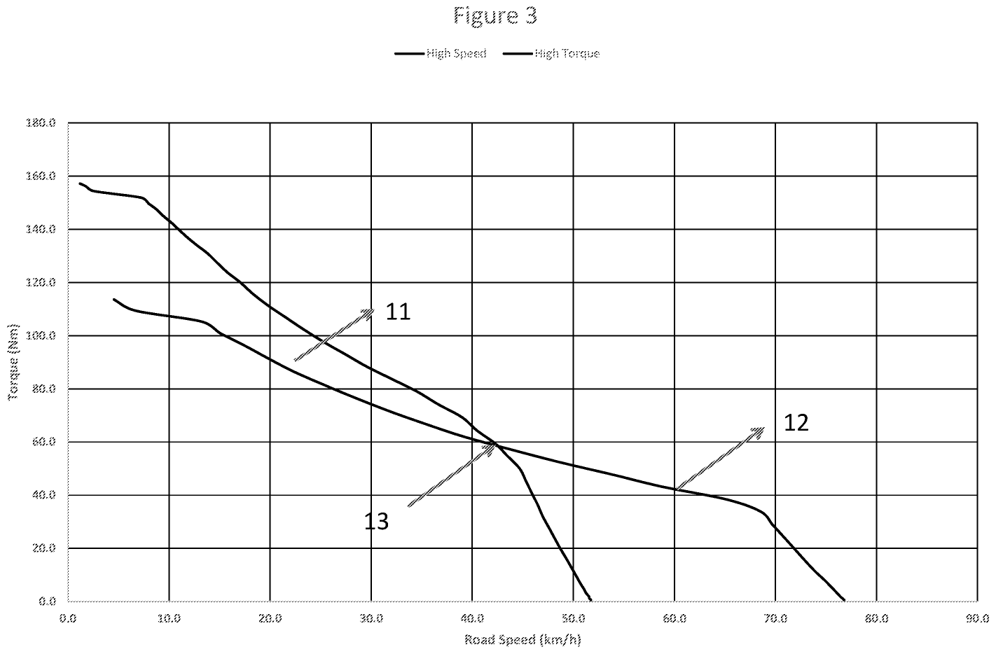

Referring to FIG. 3, for the same electric machine (9) a plot of the Torque (Nm) vs. Road Speed (km/hr.) characteristic is shown when terminated in wye (11) and when terminated in delta (12).

At low speed the wye termination has a greater torque but at particular point (13) the delta termination continues to have a higher speed and higher torque characteristic.

The additional benefit is that in delta termination the Kv is higher which results in a lower voltage requirement to achieve the same rpm. This allows more energy to be drawn from the ultra-capacitor and the on-board charging system, which in turn allows operation at higher speeds with lower rpm.

In embodiments to achieve an optimum torque and speed characteristic and a reduction in rpm requirement for the on-board charging system an electric on the fly switching between wye and delta is implemented. This is implemented by using a contact relay that is controlled by the ECU microprocessor. The phase ends of the electric machine/s' (9) windings are taken to a contact relay. During switching, the current draw from electric machine controller/s (8) and or throttle is disabled for safe smooth transition.

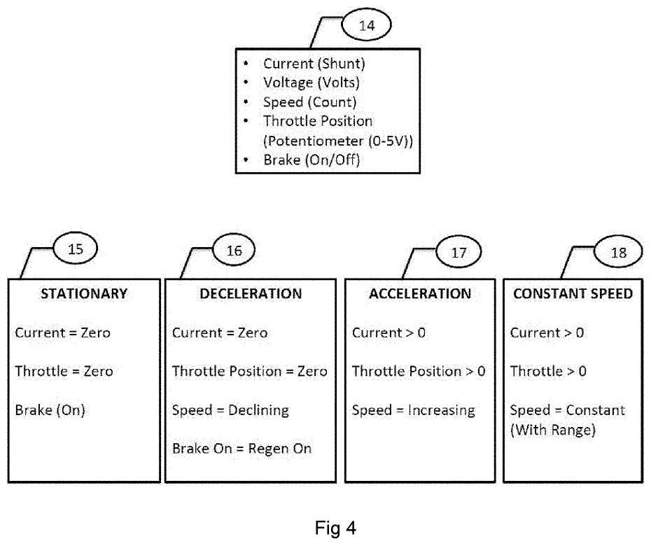

Referring to FIG. 4, to operate efficiently the on-boarding charging system (10) needs to know what state; stationary (15), deceleration (16), acceleration (17), constant speed (18) the vehicle is in. The inputs (14); Current, Voltage, Throttle Position, Vehicle Speed and Brake can be read by the ECU microprocessor.

During the stationary state (15) the current will be zero, the throttle position sensor will be zero, and the brake switch on. During deceleration (16) the current will be zero, the throttle position will be zero, the speed will be declining in time, and the brake switch may be on or off.

During acceleration (17) the current will be greater than zero, the throttle position will be greater than zero, and the speed will be increasing with time. During constant speed (18) the current will be greater than zero, the throttle will be greater than zero, and the change of speed in time will be in a small range.

During deceleration (16) the brake may be on in which case regeneration can be activated by the electric machine controller/s (8).

In embodiments to optimize the operation of the on-board charging system (10) the states; stationary (15), deceleration (16), acceleration (17), constant speed (18) are identified by values of inputs (14); Current, Voltage, Throttle Position, Vehicle Speed and Brake position. Additionally the fuel consumption vs torque vs rpm map is stored in an ECU microprocessor and “sweet spot” known for the Internal Combustion Engine. The inputs are read by the ECU microprocessor to determine the operation of the on-board charging system to optimize performance, fuel and emission saving and maintain vehicle operation speed and load requirements.

Referring to Table 3 which summarizes the fuel consumed on a WMTC Test Cycle.

TABLE 3 shows the average % fuel used in mL by a 100 cc two-wheeler with CVT transmission in the states of stationary, acceleration, constant speed and deceleration during the WMTC Stage 1 test cycle.

TABLE 3

| | Total | | Total | | Average |
|---|---|---|---|---|---|
| Mode | Time | % Time | Fuel (mL) | % Fuel | mL/s |
| Acceleration | 194 | 32.2 | 34.68 | 41.3 | 18.1 |
| Deceleration | 140 | 23.2 | 18.51 | 22.1 | 15.1 |
| Stationary | 109 | 18.1 | 4.22 | 5.0 | 5.3 |
| Constant | 160 | 26.5 | 26.51 | 31.6 | 21.1 |
| Totals | 603 | 100 | 83.92 | 100 | |

During deceleration 22.1% of the total fuel of the cycle is consumed as wasted energy. This is due to the closed throttle position on a carburettor while the petrol motor draws fuel from the idle port.

During stationary periods 5.0% of the total fuel of the cycle is consumed as wasted energy. This is due to idling of motor at 1500 rpm.

During states of deceleration (16) and stationary (15), the vehicle does not do work.

In embodiments the operation of the on-board charging system (10) can determine by the states (15-18) the vehicle is in.

To maximize fuel and emissions savings the on-board charging system's ICE (3) can be turned off when work is not being done by the vehicle and the ultra-capacitor pack (7) is fully charged. Work is not being done during stationary (15) and deceleration (16) states. If the ultra-capacitor pack (7) is not fully charged the ultra-capacitor (7) is rapidly charged during these states until it is full using constant current and running the ICE (3) at its “sweet spot”. This could involve the engine throttle being opened to produce sufficient power required to charge the UCs and run at its “sweet spot”. Once the ultra-capacitor's (7) full capacity is reached then the on-board charging system (10) including the ICE (3) is turned off.

To maximize the fuel and emission saving during acceleration state the energy in the ultra-capacitor (7) is discharged.

The on-board charging system (10) can be used to recharge the UCs during their discharge and/or can be used to replace the UC power when the UCs drop to or below a threshold voltage/current they are able to deliver by the ICE generator providing a higher or matched charging current to discharge current.

In ideal cases the capacity of the ultra-capacitor (7) is selected for the typical acceleration gradient and acceleration time period so that the full acceleration can be captured on the stored energy of the ultra-capacitor (7).

The ICE (3) can be run at its “sweet spot” during charging of the ultra-capacitors to increase available time to run in electric powertrain or provide energy for further acceleration states.

During constant speed states the energy in the ultra-capacitor (7) is used first then the on-board charging system (10) turned on to provide power requirement to sustain constant speed.

At any time while the on-board charging system (10) is on, the rpm of the ICE (3) can be varied to ensure that the voltage delta between the on-board charging system (10) and the ultra-capacitor (7) is such that it induces a sufficient current so that the product of voltage and current supplied produces the required power to maximize fuel and emissions reductions and charge the ultra-capacitor (7) so that the energy is more readily available for acceleration (17) states.

At any time, the ultra-capacitor (7) is being discharged and the on-board charging system (10) is off, the on-board charging system (10) may be turned on at any time, to sustain voltage and load demand by the application.

In embodiments during periods when the brake is applied, the electric machine controller/s (8) may activate regeneration to provide electric braking and charge the ultra-capacitor (7).

In various embodiments the energy stored in the ultra-capacitor (7) can be used during acceleration (17) states. The energy can be recovered using the on-board generator (10) during acceleration, low constant speed or deceleration states where torque demand is sufficiently low to run the ICE (3) at its “sweet spot”.

In various embodiments during constant low speed states energy stored in the ultra-capacitor (7) is discharged until a low voltage set point is reach. At this point the on-board charger (10) is turned on to recharge the ultra-capacitor with the ICE (3) running at its “sweet spot”.

In embodiments during deceleration (16) states the ICE (3) is turned off when the ultra-capacitor pack (7) is fully charged.

In embodiments during stationary (15) states the ICE (3) is turned off when the ultra-capacitor pack (7) is fully charged.

In embodiments during acceleration (17) states the energy stored in the ultra-capacitor (7) is discharged until a low voltage set point is reached. At this point the on-board charger (10) is turned on to recharge the ultra-capacitor (7).

In embodiments during acceleration (17) states the energy stored in the ultra-capacitor (7) is discharged. If there is sufficient torque to run the ICE (3) at its “sweet spot” during acceleration the on-board charger (10) is turned on to recharge the ultra-capacitor (7).

In various embodiments, the ECU microprocessor may store history of states over time to predict the best control strategy to implement for the on-board charging system (10).

TABLE 4 is a comparison of energy used for first acceleration and longest constant speed section of the WMTC test cycle for a 100 cc moped and a fully electric moped using an electric machine in rear wheel.

TABLE 4

POWERTRAIN TYPE

| Section of WMTC | Internal Combustion | Electric Hub Motor |
|---|---|---|
| Test Cycle | Engine/Gasoline Fuel | with Ultracapacitor |
| Longest Constant | 11.27 ml (387034 Joules) | (35.6 V Vmax to 28.28 V |
| Speed section WMTC | | Vmin (43875 Joules) |
| First Acceleration | 1.48 ml (50826 Joules) | 39.78 V Vmax to 37.76 V |
| of WMTC | | Vmin (14665 Joules) |

A first-generation system as part of the development process of the present invention is described below. The original test results for a first-generation system are shown in TABLE 5 below.

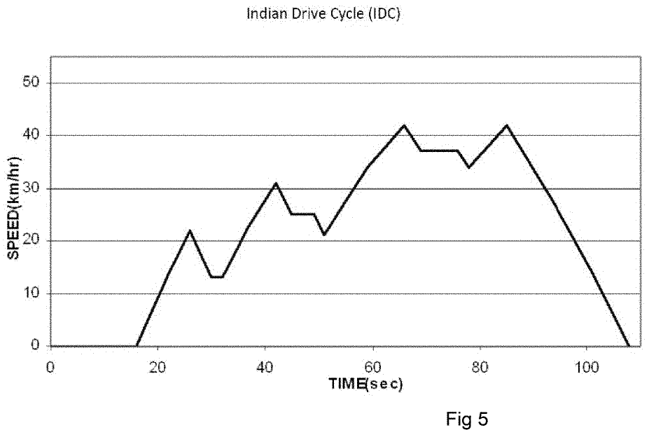

The test cycle shown is FIG. 5 is called IDC (Indian Drive Cycle) which was the standard test cycle for two-wheelers in India at the time.

The results proved a 38% reduction in fuel consumption for the test cycle compared to a baseline conducted on a 100 cc two-wheeler with CVT transmission. The fuel consumption is broken down into acceleration, stationary, charging and deceleration sections in millilitres (ml).

TABLE 5
Summary - data logs

| | | | No. of | |
|---|---|---|---|---|
| | | | cycles | |
| | | | (ignoring | |
| Fuel/Speed | Hybrid | Voltage/ | first | |
| file (ARAI) | Program ID | Current | cycle) | Notes |
| Test A | EngCt1005 | No file | 7 | Voltage adjust |
| 17_23_34 | | | | |
| Test B | EngCt1005 | Test006csv | 7 | |
| 10_50_53 | | | | |
| Test C | EngCt1007 | Test007csv | 4 | Change lower |
| 11_21_35 | | | | voltage and high |
| | | | | speed fuel cut |
| Test D | EngCt1008 | Test008csv | 4 | Change to lower |
| 11_54_12 | | | | fuel cut out speed |
| Test E | EngCt1008 | Test010csv | 12 | |
| 16_42_48 | | | | |

Results

Test C 11_54_12

| | Fuel | | | | Total Fuel | |
|---|---|---|---|---|---|---|
| | used | Fuel | | | save compared | |
| | electric | Charging | Fuel Decel | Total Fuel | to baseline | Average |
| Cycle | (Litres) | (Litres) | (Litres) | (Litres) | 0.01018 | fuel save |
| 1 | 0 | 0.00612027 | 0.000686874 | 0.006807141 | 33.13% | 35% |
| 2 | 0 | 0.00533641 | 0.001154757 | 0.006491167 | 36.24% | |
| 3 | 0 | 0.00557625 | 0.000957789 | 0.006534043 | 35.81% | |
| 4 | 0 | 0.00593892 | 0.000739575 | 0.006678498 | 34.40% | |

Test E 16_42_48

| | Fuel | | | | Total Fuel | |
|---|---|---|---|---|---|---|
| | used | Fuel | | | save compared | |
| | electric | Charging | Fuel Decel | Total Fuel | to baseline | Average |
| Cycle | (Litres) | (Litres) | (Litres) | (Litres) | 0.01018 | fuel save |
| 1 | 0 | 0.005273931 | 0.001234236 | 0.006508167 | 36.07% | 38% |
| 2 | 0 | 0.004774961 | 0.001082273 | 0.005857234 | 42.46% | |
| 3 | 0 | 0.005445791 | 0.001193377 | 0.006639168 | 34.78% | |
| 4 | 0 | 0.005126517 | 0.001258192 | 0.006384709 | 37.28% | |
| 5 | 0 | 0.00538188 | 0.001241119 | 0.006622999 | 34.94% | |
| 6 | 0 | 0.004866179 | 0.001060139 | 0.005926318 | 41.78% | |
| 7 | 0 | 0.005422308 | 0.001200486 | 0.006622794 | 34.94% | |
| 8 | 0 | 0.005214421 | 0.001062089 | 0.00627651 | 38.34% | |
| 9 | 0 | 0.005246865 | 0.001121837 | 0.006368702 | 37.44% | |
| 10 | 0 | 0.004922512 | 0.001094775 | 0.006017287 | 40.89% | |
| 11 | 0 | 0.005397035 | 0.001113345 | 0.00651038 | 36.05% | |
| 12 | 0 | 0.004786285 | 0.001046696 | 0.005832981 | 42.70% | |

TestC 11_21_35

| | Fuel | | | | Total Fuel | |
|---|---|---|---|---|---|---|
| | used | Fuel | | | save compared | |
| | electric | Charging | Fuel Decel | Total Fuel | to baseline | Average |
| Cycle | (Litres) | (Litres) | (Litres) | (Litres) | 0.01018 | fuel |
| 1 | 0 | 0.005356275 | 0.000714215 | 0.00607049 | 40.37% | 39% |
| 2 | 0 | 0.005737186 | 0.001105474 | 0.00684266 | 32.78% | |
| 3 | 0 | 0.004886485 | 0.001132035 | 0.00601852 | 40.88% | |
| 4 | 0 | 0.005207725 | 0.000885805 | 0.00609353 | 40.14% | |

Test A 17_23_34

| | Fuel | | | | Total Fuel | |
|---|---|---|---|---|---|---|
| | used | Fuel | | | save compared | |
| | electric | Charging | Fuel Decel | Total Fuel | to baseline | Average |
| Cycle | (Litres) | (Litres) | (Litres) | (Litres) | 0.01018 | fuel save |
| 1 | 0 | 0.006125859 | 0.0007 | 0.006825859 | 32.95% | 33% |
| 2 | 0 | 0.005863396 | 0.00101 | 0.006873396 | 32.48% | |
| 3 | 0 | 0.005694258 | 0.00075 | 0.006444258 | 36.70% | |
| 4 | 0 | 0.005926909 | 0.00087 | 0.006796909 | 33.23% | |
| 5 | 0 | 0.005614755 | 0.00099 | 0.006604755 | 35.12% | |
| 6 | 0 | 0.006055288 | 0.00069 | 0.006745288 | 33.74% | |
| 7 | 0 | 0.006553357 | 0.00074 | 0.007293357 | 28.36% | |

Test B 10_50_53

| | Fuel | | | | Total Fuel | |
|---|---|---|---|---|---|---|
| | used | Fuel | | | save compared | |
| | electric | Charging | Fuel Decel | Total Fuel | to baseline | Average |
| Cycle | (Litres) | (Litres) | (Litres) | (Litres) | 0.01018 | fuel save |
| 1 | 0 | 0.0058078 | 0.00116 | 0.0069678 | 31.55% | 29% |
| 2 | 0 | 0.00561421 | 0.000947 | 0.00656121 | 35.55% | |
| 3 | 0 | 0.00690654 | 0.000907 | 0.00781354 | 23.25% | |
| 4 | 0 | 0.0063928 | 0.001013 | 0.0074058 | 27.25% | |
| 5 | 0 | 0.00701493 | 0.000712 | 0.00772693 | 24.10% | |
| 6 | 0 | 0.00575713 | 0.001077 | 0.00683413 | 32.87% | |
| 7 | 0 | 0.0065704 | 0.000904 | 0.0074744 | 26.58% | |

The first-generation system only had one electric machine directly coupled to the rear wheel through a fixed 10:1 reduction gearbox. The electric machine had the function of discharging as an electric motor from 0-34 km/hr with the energy stored in an ultra-capacitor bank. For Speeds above 30 km/hr and when the voltage of the ultra-capacitor reached a low setpoint of 28V the internal combustion engine was started, and drive was done by the internal combustion engine. In addition, at speeds above 34 km/hr due to the electric machine being directly coupled to the rear wheel it would act as a generator for speeds above 30 km/hr and charge the ultracapacitor. An ultracapacitor pack comprising seventeen 2.7V, 1250 Farad cells in series was used in the vehicle.

When initially testing on the IDC cycle the energy from the charged ultra-capacitor was used and the electric machine drove the vehicle up to 55 seconds of the 108 second cycle. When a speed greater than 34 km/hr was reached and when the voltage of the ultra-capacitor reached a low setpoint of 28V the petrol motor was started and drove the vehicle while also driving the electric machine to charge the ultracapacitor. By the time the final deceleration is reached in the cycle the petrol motor is turned off as the ultra-capacitor is fully charged back to its original state of 42V.

This resulted in a 38% fuel save. This was a significant result and unexpected. It was known from previous tests that while in electric drive, due to the efficiency of the electric drive system less energy is used to achieve the same cycle (work) than if the internal combustion engine had been used for drive. What was unexpected was that during charging which occurred from 55 seconds into the IDC drive cycle and completed at 85 seconds in the IDC drive cycle even though the load had increased the fuel used during this period still resulted in an overall fuel save of 38%.

It was identified that charging had occurred when the ICE was being operated at its optimum brake specific fuel consumption (BSFC) and is also reffered to as the “sweet spot”. The ICE had sufficient torque to provide drive for the vehicle and also charge the ultra-capacitor in a range of 20-30 Amps so that the full charge was reached by the final deceleration of the IDC cycle.

Unlike Lithium Ion batteries, the ultra-capacitor was not the component limiting the charging it was the torque capacity of the ICE. A significant discovery was made that if the internal combustion engine is operated at its “sweet spot” during charging and there is sufficient torque to drive the vehicle and charge, overall a signficant fuel save could be achieved on a cycle

Further changes to the voltage setpoints for when to start charging produced best results of 42% compared to the baseline on the IDC drive cycle. Active balancing circuitry between individual ultra-capacitor cells was implemented early on to avoid variations in voltage of individual cells which limit current flow in a series set-up. There was also some fuel save due to implementing fuel cut off during deceleration.

Because the electric machine was directly coupled to the rear wheel it was dependent on the speed of the bike to enable rotation and charging, which was a major negative of the first-generation system.

It is was identifed that it would be preferable to control the generator rpm and charging through the rpm of the internal combustion engine. This could be achieved by moving the generator to the crankshaft of the engine as opposed to being attached to the rear wheel. This would enable the internal combustion engine to operate at its “sweet spot” on demand and charge the ultra-capacitor.

The load on the petrol motor was higher at speeds above 34 km/hr and charging as the petrol motor was driving both the vehicle and the electric machine which was generating electricity to charge the ultracapacitors.

As the speed increased, the rpm of the electric machine increased causing a higher charging current that put further load on the petrol motor, which ultimately negatively effected drivability performance and could move the ICE out of its “sweet spot”.

It was identified that some form of clutch or solenoid switch is preferred in order to disengage the ultra-capacitor load either when the torque demand, or speed of the vehicle is greater than what the internal combustion could achieve at its “sweet spot” while charging. This would allow the vehicle to operate without a charging load.

The first-generation system is very sensitive to changes in drive cycle. For example, if customers always drove at speeds below 34 km/hr it would not take long for the energy to be used, then the petrol motor would always be on and no charging would occur as the bike needed to be doing more than 34 km/hr.

It was identified that it would be preferable to control the generator rpm and charging through the rpm of the internal combustion engine. This could be achieved by moving the generator to the crankshaft of the engine as opposed to being attached to the rear wheel. This would enable the internal combustion engine to operate at its “sweet spot” on demand more often and charge the Ultra-capacitor more regularly without a reliance on speed of vehicle.

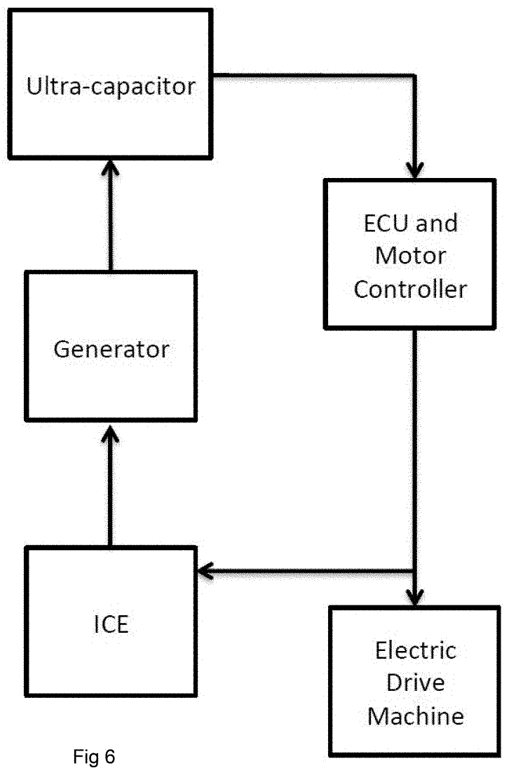

FIG. 6 shows a configuration of the present invention utilising Electric Drive with the ICE operating the generator. Drive is provide by the electric powertrain with the ICE only connected to the generator to charge the capactivie energy storage, such as an ultra-capacitor. The ICE is run at its “sweet spot” to charge the ultra-capacitor and maintain sufficient power for the electric powertrain as described in the invention.

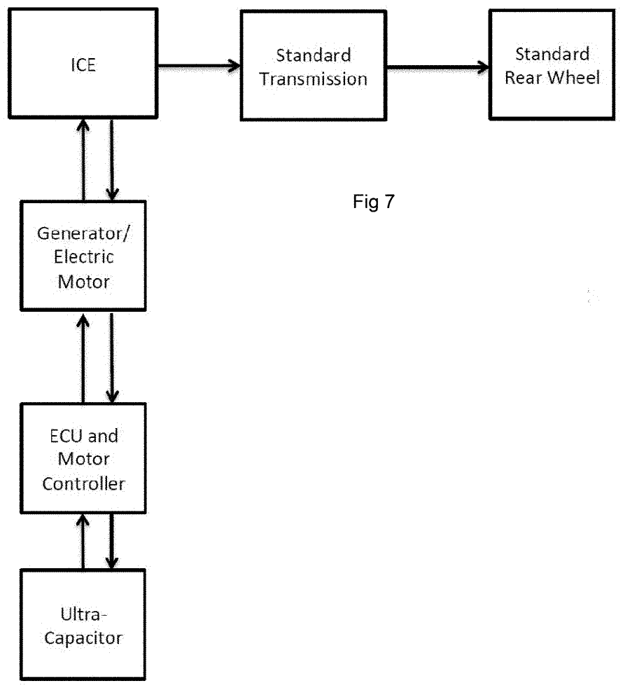

FIG. 7 shows a configuration of the present invention with the ICE using mechanical drive and Electric Power Assist. In this configuration, the electric machine is connected to the crankshaft. The ICE can drive the vehicle through the transmission to the wheel. The electric machine can provide power assist to the ICE when there is sufficient charge in the ultra-capacitor to maintain its operation “at the sweet spot”. The electric machine can also charge the ultra-capacitor on demand as described in Invention.

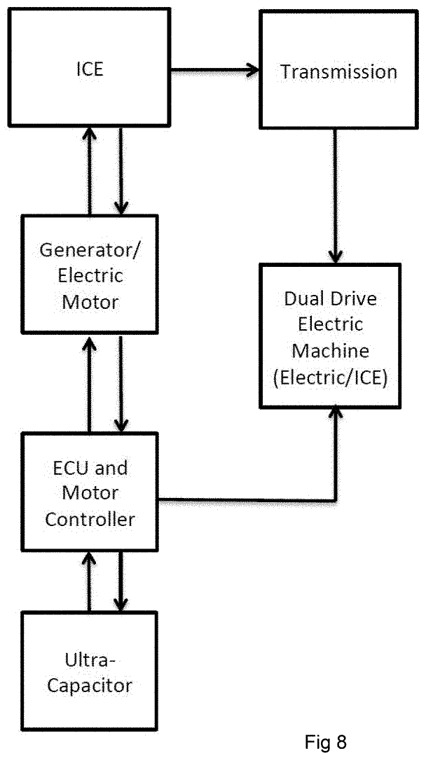

FIG. 8 shows the ICE with mechanical drive, electric drive and Electric Power Assist. In this configuration, the electric machines can be connected to the crankshaft as wheel as drive wheels. The ICE can drive the vehicle through the transmission to the wheel. The electric machine/s can provide power assist to the ICE when there is sufficient charge in the ultra-capacitor to maintain its operation “at the sweet spot”. The electric machine can also charge the ultra-capacitor on demand as described in the invention. Additionally pure electric drive is available when the ultra-capacitor has sufficient charge.

### EMBODIMENTS

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

Similarly, it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Different Instances of Objects

As used herein, unless otherwise specified the use of the ordinal adjectives “first”, “second”, “third”, etc., to describe a common object, merely indicate that different instances of like objects are being referred to and are not intended to imply that the objects so described must be in a given sequence, either temporally, spatially, in ranking, or in any other manner.

Specific Details: In the description provided herein, numerous specific details are set forth. However, it is understood that embodiments of the invention may be practiced without these specific details. In other instances, well-known methods, structures and techniques have not been shown in detail in order not to obscure an understanding of this description.

Terminology: In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

Comprising and Including: In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

Scope of Invention: Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### INDUSTRIAL APPLICABILITY

It is apparent from the above, that the arrangements described are applicable to a system and apparatus for the motoring and vehicle industry.

What is claimed is:

1. A method of operating a hybrid power system for powering a vehicle or stationary apparatus having a variable load demand, the method comprising:
operating an internal combustion engine (ICE); and
operating a generator or electric machine to charge/recharge capacitive energy storage of at least one electrical energy storage device during acceleration or high load demand on the ICE.

2. The method of claim 1, wherein on-board charging is used to recover the energy in the capacitive energy storage such that the energy is available for a subsequent acceleration cycle of the vehicle.

3. The method of claim 1, wherein the acceleration or high load demand is at or near full throttle opening of the ICE.

4. The method of claim 1, wherein the acceleration or high load demand is at least at 30% or above of throttle opening or of maximum torque capacity of the ICE.

5. The method of claim 1, further comprising controlling operation of the ICE to operate within a desired range of revolutions per minute (rpm) or at desired rpm to charge/recharge the capacitive energy storage.

6. The method of claim 1, wherein the capacitive energy storage includes at least one ultra-capacitor, at least one super capacitor, or a combination of the at least one ultra-capacitor and the at least one super capacitor.

7. The method of claim 1, further comprising transitioning operation of the ICE from a first mode of operation to a second, more efficient mode of operation for the ICE than the first mode of operation, when charging/recharging capacitive energy storage of at least one electrical energy storage device.

8. The method of claim 7, wherein the ICE is controlled to operate in the second mode of operation while the capacitive storage of at least one electrical energy storage device is used to power at least one said electric machine.

9. The method of claim 7, wherein the second mode of operation of the ICE is a higher fuel efficiency mode of operation and/or at a preferred emissions output of the ICE than the first mode of operation.

10. The method of claim 7, wherein the ICE is controlled to return to the first mode of operation when the capacitive energy storage is charged/recharged to or above a threshold voltage or is controlled to maintain the capacitive energy storage at or above a threshold voltage or charge level.

11. The method of claim 7, further comprising optimising weighted average fuel efficiency of the ICE by controlling the ICE to transition from the first mode of operation to the second mode of operation to charge/recharge the capacitive energy storage when the second mode of operation is more fuel efficient for the ICE than the first mode when the capacitive energy storage is to be charged/recharged.

12. The method of claim 1, wherein, when the method is applied to operation of a vehicle, regenerative braking is not provided or is not used to charge/recharge the capacitive energy storage when the ICE is operated in a mode to charge/recharge the capacitive energy storage.

13. The method of claim 1, wherein, at relatively lower efficiency operational mode of the ICE the at least one electrical energy storage device is used to power or augment powering of the vehicle or the stationary device, and at a relatively higher efficiency operational mode of the ICE the ICE is used to charge/recharge the at least one electrical energy storage device.

14. The method of claim 1, wherein the ICE is put to an idle mode or turned off during a period when the at least one electrical energy storage device is powering the vehicle or the stationary device, or wherein the ICE is operated to charge/recharge the at least one electrical energy storage device when an output voltage of the at least one electrical energy storage device falls to or below a threshold value.

15. The method of claim 1, wherein, during constant speed states, the energy in the capacitive energy storage is used first then charging/recharging is (re)commenced to provide a power requirement to sustain constant speed.

16. The method of claim 1, wherein rpm of the ICE is varied to ensure that a voltage delta between charging voltage and a voltage of the capacitive energy storage is such that a sufficient current is provided so that the product of voltage and current supplied produces the required power to maximize fuel efficiency reductions and charge the capacitive energy storage so that the stored electrical energy is available for acceleration states.

17. A hybrid power system for powering a vehicle or stationary apparatus having a variable load demand, the system comprising:
an internal combustion engine (ICE) controlled to operate a generator or electric machine to charge/recharge capacitive energy storage of at least one electrical energy storage device during acceleration or high load demand on the ICE.

18. The system of claim 17, wherein the acceleration or high load demand is at full throttle opening of the engine.

19. The system of claim 17, wherein the acceleration or high load demand is at least at 30% or above of throttle opening or of maximum torque capacity of the ICE.

20. The system of claim 17, further comprising:
at least one electrical energy storage device including the capacitive energy storage;
at least one internal combustion engine (ICE) operatively connected to drive a charging system, such as an on-board charging system and/or an electric power source, such as a generator or electric machine, for use in charging/recharging at least the capacitive energy storage; and
a controller arranged and configured to control the ICE to transition operation from a first mode to a second mode more fuel efficient than the first mode when charging/recharging the capacitive energy storage.

21. The system of claim 17, wherein the ICE is configured to operate within a desired range of revolutions per minute (rpm) in the second mode sufficient to charge/recharge the capacitive storage of the at least one energy storage device.

22. The system of claim 20, wherein the controller is configured to operate the ICE to charge/recharge the capacitive energy storage to maintain the at least one electrical energy storage device and/or the capacitive energy storage at or above a minimum voltage.

23. The system of claim 20, wherein controller is configured to transition operation of the ICE from a first mode to a second mode, the second mode being of higher rpm that the first mode, to charge/at least the capacitive energy storage.

24. The system according to claim 20, wherein a state of the system determines operation of the on-board charging system and/or an electric power source and wherein the controller, such as an ECU, is configured to receive one or more inputs of: voltage, current, throttle position, brake pedal position, torque demand, rpm and speed.

25. The system according to claim 24, wherein the states are identifiable by the values of the inputs:
during the stationary state the current will be zero, the throttle position sensor will be zero, and the brake switch on; or
during deceleration the current will be zero, the throttle position will be zero, the speed will be declining in time, and the brake switch may be on or off; or
during acceleration the current will be greater than zero, the throttle position greater than zero, and the speed will be increasing with time; or
during constant speed the current will be greater than zero, the throttle will be greater than zero, and the change in speed in time will be in a small range; or
during deceleration and with brake on regeneration can be activated.

26. The system according to claim 20, including an optimized charging system and/or an electric power source for high voltage output at low rpm (low Kv) and high output current at low rpm or including an optimized internal combustion engine (ICE) with high torque output at low rpm.
